(19) United States
(12) Patent Application Publication
(10) Pub. No.: US 2006/0137205 A1
(43) Pub. Date: Jun. 29, 2006

(54) Composite washing system

(75) Inventors: Deug Hee Lee, Gimhae-si (KR); Hung Myong Cho, Jillye-myeon (KR); Byung Hwan Ahn, Gimhae-si (KR); Soung Bong Choi, Changwon-si (KR); Young Soo Kim, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Youngdungpo-gu (KR)

(21) Appl. No.: 11/289,655

(22) Filed: Nov. 30, 2005

(30) Foreign Application Priority Data
Nov. 30, 2004 (KR) 10-2004-99158

(51) Int. Cl. F26B 19/00; F26B 25/18; F26B 11/18

(52) U.S. Cl. 34/60; 34/239; 34/200

(57) ABSTRACT

A composite washing system is disclosed which is capable of continuously circulating laundry-drying air through dryers while obtaining a more efficient drying effect, so that the composite washing system has a suitable built-in structure having minimal influence on the indoor environment. The composite washing system includes a drum dryer which dries laundry to be dried, and includes a drying drum adapted to receive the laundry, a hot air supply path adapted to guide a flow of hot air, a hot air supplier arranged in the hot air supply path to generate the hot air, and an air condenser adapted to condense the hot air, a cabinet dryer which is coupled to one side of the drum dryer, and is defined with a laundry receiving compartment, the cabinet dryer including a hot air adapted to receive the hot air flowing through the hot air supply path, and a laundry folder which is disposed in the cabinet dryer to receive laundry having a long length without wrinkling the laundry.

This application claims the benefit of Korean Patent Application No.P2004-99158 filed on Nov. 30, 2004 which is hereby incorporated by reference as if fully set forth herein.

### BACKGROUND OF THE INVENTION

1. Field of the Invention

The present invention relates to a drying apparatus, and more particularly, to a composite washing system which is capable of continuously circulating laundry-drying air through dryers while obtaining a more efficient drying effect, so that the composite washing system has a suitable built-in structure.

2. Discussion of the Related Art

Generally, laundry dryers are adapted to dry laundry such as clothes. Such a laundry dryer receives completely-washed laundry, and then performs an operation to dry the laundry while continuously supplying hot air.

FIG. 1 illustrates a general drum dryer as an example of a conventional laundry dryer.

As shown in FIG. 1, the conventional drum dryer mainly includes a body 10, a drying drum 20, a door 40, a motor 50, a drying heater 60, and a blowing fan 70.

The body 10 defines an appearance of the drum dryer. The drying drum 20 is rotatably disposed in the body 10. A laundry inlet 11 is formed through the front of the body 10. The door 40 is mounted to the front of the body 10 to open and close the laundry inlet 11.

The motor 50 is fixedly mounted on the bottom of the body 10 inside the body 10. The motor 50 generates a drive force to rotate the drying drum 20 and the blowing fan 70.

The drying heater 60 is arranged in a hot air supply path 91 in order to heat air flowing through the hot air supply path 91. The hot air supply path 91 guides a flow of hot air supplied into the drying drum 20.

The blowing fan 70 operates to outwardly discharge the hot air, namely, drying air, flowing through the interior of the drying drum 10. The blowing fan 70 communicates with a hot air discharge path 92.

In accordance with the above-mentioned configuration, when the blowing fan 70 operates, air around the laundry dryer, namely, ambient air, is introduced into the body 10, is heated while passing through the drying heater 60, and is then introduced into the drying drum 20 while being guided by the hot air supply path 91.

Accordingly, wet laundry received in the drying drum 20 is gradually dried by the hot air.

The air used to dry the laundry while passing through the drying drum 10 is outwardly discharged while being guided by the hot air discharge path 92.

When the laundry is completely dried in accordance with repeated execution of the above-mentioned procedure, the operations of the blowing fan 70 and drying heater 60 are stopped to complete the drying cycle.

In the conventional drum dryer, however, there is a problem in that laundry is inefficiently dried because the drying cycle is carried out while the laundry is in an entangled state.

Furthermore, there is a problem in that the laundry cannot be maintained in the dryer.

To this end, a demand for a new laundry dryer has recently been made which has an increased drying capacity and enables storage of dried laundry for a prolonged period of time. To satisfy this demand, a combination type dryer has been developed, as disclosed in U.S. Published Patent Application Nos. 2004/0194339 A1 and 2004/0154194 A1. Such a combination type dryer includes a separate drying cabinet, in addition to a drum dryer, namely, a tumble dryer.

In such a combination type dryer, a drying cabinet, which has a drying compartment for various clothes, is mounted on the top of a general drum dryer having a rotatable drum such that hot air is supplied to the drying cabinet.

The drying cabinet receives hot air supplied from the drum dryer to dry clothes received in the drying cabinet. The drying cabinet may also be used to store the dried clothes for a prolonged period of time.

However, the above-mentioned combination type dryer has a problem in that it cannot be of a built-in type because it has an air discharge type structure in which the air used to dry laundry is outwardly discharged from the dryer.

In other words, where the combination type dryer is built in a wall, it is necessary to provide a sufficient built-in space to provide a sufficient gap from the surface of the wall such that air is adequately discharged away from the dryer. For this reason, the appearance of the dryer is unattractive.

Furthermore, the air discharged from the combination type dryer is hot and humid, thereby causing the indoor environment to be an environment undesirable for the user, namely, a high-temperature and humid environment.

In addition, in order to receive laundry having a long length, such as trousers, in the laundry compartment of the drying cabinet in the conventional combination type dryer, the laundry compartment of the drying cabinet is connected with a part of the space defined in the drum dryer. For this reason, there is a problem in that the drum, which is disposed in the drum dryer, must be of a limited size.

### SUMMARY OF THE INVENTION

Accordingly, the present invention is directed to a composite washing system that substantially obviates one or more problems due to limitations and disadvantages of the related art.

An object of the present invention is to provide a composite washing system which is capable of continuously circulating air to dry laundry contained in a drying drum and laundry contained in a drying cabinet, and uniformly drying the laundry contained in the drying cabinet.

Another object of the present invention is to provide a composite washing system which can receive laundry having a long length in a drying cabinet without wrinkling the laundry.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a composite washing system comprises: a drum dryer which dries laundry to be dried, and includes a drying drum adapted to receive the laundry, a hot air supply path adapted to guide a flow of hot air, a hot air supplier arranged in the hot air supply path to generate the hot air, and an air condenser adapted to condense the hot air; a cabinet dryer which is coupled to one side of the drum dryer, and is defined with a laundry receiving compartment, the cabinet dryer including a hot air inlet duct adapted to receive the hot air flowing through the hot air supply path; and a laundry folder which is disposed in the cabinet dryer to receive laundry having a long length without wrinkling the laundry.

The hot air supply path may include a first air supply duct which guides the hot air into the drying drum, a second air supply duct which is connected to the first air supply duct and the hot air inlet duct to guide the hot air generated from the hot air supplier into at least one of the first air supply duct and the hot air inlet duct, and a third air supply duct which guides air discharged from the drying drum to the air condenser.

The composite washing system may further comprise a filter which is arranged in the third air supply duct to filter the air discharged from the drying drum, and thus, to remove foreign matter contained in the discharged air.

The laundry folder may include at least one folding rod which is detachably mounted in the cabinet dryer to fold a portion of the laundry, and a folding rod guide which is disposed in the cabinet dryer to hold the folding rod in a fixed state and to guide a movement of the folding rod.

The folding rod may include a seat member on which the laundry is seated, and a position fixing member which extends from one end of the seat member to fix a position of the folding rod.

The folding rod guide may include an insertion groove in which the position fixing member of the folding rod is insertable, a first guide which extends horizontally from the insertion groove to guide a horizontal movement of the folding rod, a second guide which extends vertically from the first guide to guide a vertical movement of the folding rod, and at least one fixing groove which is formed at one side of the second guide to fix a position of the folding rod.

The first guide may include a first guide groove which receives the position fixing member of the folding rod to allow the position fixing member to move along the first guide, and first separation preventing grooves which are formed along opposite edges of the first guide groove, respectively, to prevent the position fixing member from being separated from the first guide groove.

The second guide may include a second guide groove which receives the position fixing member of the folding rod to allow the position fixing member to move along the second guide, and second separation preventing grooves which are formed along opposite edges of the second guide groove, respectively, to prevent the position fixing member from being separated from the second guide groove.

The composite washing system may further comprise a laundry support which is disposed in the cabinet dryer to support the laundry in the cabinet dryer.

The laundry support may include at least one shelf detachably mounted in the cabinet dryer to support the laundry in such a manner that the laundry is laid on the shelf, and a hanger bar detachably mounted in the cabinet dryer at an upper portion of the cabinet dryer to support the laundry in such a manner that the laundry is hung on the hanger bar.

In accordance with another aspect of the present invention, a composite washing system comprises: a drum dryer which dries laundry to be dried, and includes a drying drum adapted to receive the laundry, a hot air supply path adapted to guide a flow of hot air, a hot air supplier arranged in the hot air supply path to generate the hot air, and an air condenser adapted to condense the hot air; a cabinet dryer which is coupled to one side of the drum dryer, and is defined with a laundry receiving compartment, the cabinet dryer including a hot air inlet duct adapted to receive the hot air flowing through the hot air supply path; at least one folding rod which is detachably mounted in the cabinet dryer to fold a portion of the laundry; a folding rod guide which is disposed in the cabinet dryer to hold the folding rod in a fixed state and to guide a movement of the folding rod; and a weight which prevents the laundry seated on the folding rod in a folded state from being separated from the folding rod.

The hot air supply path may include a first air supply duct which guides the hot air into the drying drum, a second air supply duct which is connected to the first air supply duct and the hot air inlet duct to guide the hot air generated from the hot air supplier into at least one of the first air supply duct and the hot air inlet duct, and a third air supply duct which guides air discharged from the drying drum to the air condenser.

The composite washing system may further comprise a valve which is arranged in a portion of the second air supply duct connected to the first air supply duct and the hot air inlet duct, and selectively guides the hot air flowing through the second air supply duct into at least one of the first air supply duct and the hot air inlet duct.

The composite washing system may further comprise a filter which is arranged in the third air supply duct to filter the air discharged from the drying drum, and thus, to remove foreign matter contained in the discharged air.

The folding rod may include a seat member on which the laundry is seated, and a position fixing member which extends from one end of the seat member to fix a position of the folding rod.

The folding rod guide may include an insertion groove in which the position fixing member of the folding rod is insertable, a first guide which extends horizontally from the insertion groove to guide a horizontal movement of the folding rod, a second guide which extends vertically from the first guide to guide a vertical movement of the folding rod, and at least one fixing groove which is formed at one side of the second guide to fix a position of the folding rod.

The first guide may include a first guide groove which receives the position fixing member of the folding rod to allow the position fixing member to move along the first guide, and first separation preventing grooves which are formed along opposite edges of the first guide groove, respectively, to prevent the position fixing member from being separated from the first guide groove.

The second guide may include a second guide groove which receives the position fixing member of the folding rod to allow the position fixing member to move along the second guide, and second separation preventing grooves which are formed along opposite edges of the second guide groove, respectively, to prevent the position fixing member from being separated from the second guide groove.

The composite washing system may further comprise a laundry support which is disposed in the cabinet dryer to support the laundry in the cabinet dryer.

The laundry support may include at least one shelf detachably mounted in the cabinet dryer to support the laundry in such a manner that the laundry is laid on the shelf, and a hanger bar detachably mounted in the cabinet dryer at an upper portion of the cabinet dryer to support the laundry in such a manner that the laundry is hung on the hanger bar.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating an inner configuration of a conventional drum dryer;

FIG. 2 is a front view schematically illustrating a configuration of a composite washing system according to an exemplary embodiment of the present invention;

FIG. 3 is a block diagram schematically illustrating the configuration of the composite washing system according to the exemplary embodiment of the present invention;

FIG. 4 is a perspective view illustrating a structure of a laundry folder according to an exemplary embodiment of the present invention;

FIG. 5 is a cross-sectional view taken along the line I-I of FIG. 4;

FIG. 6 is a cross-sectional view taken along the line II-II of FIG. 4; and

FIG. 7 is a perspective view illustrating a state in which laundry is hung on the laundry folder according to the exemplary embodiment of the present invention.

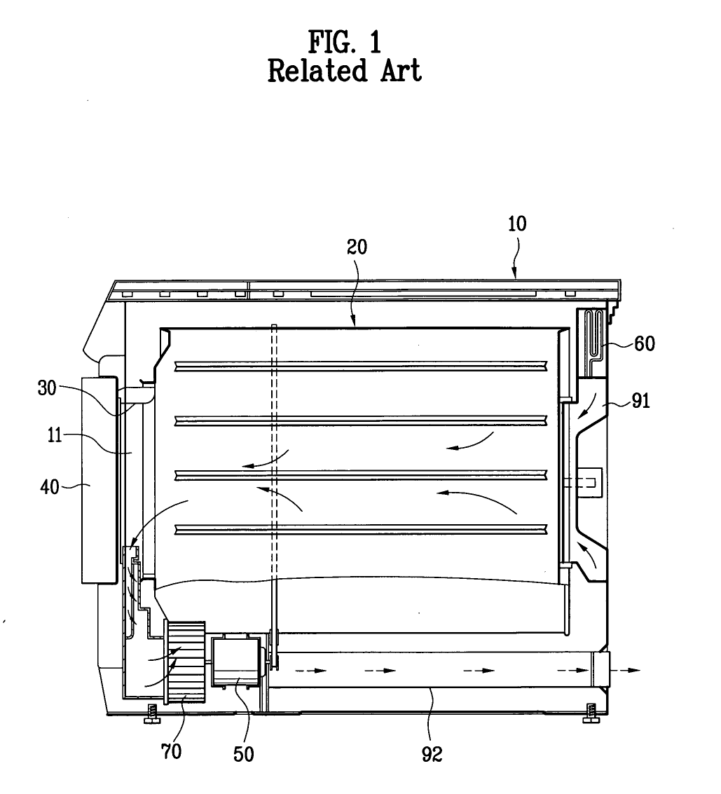

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

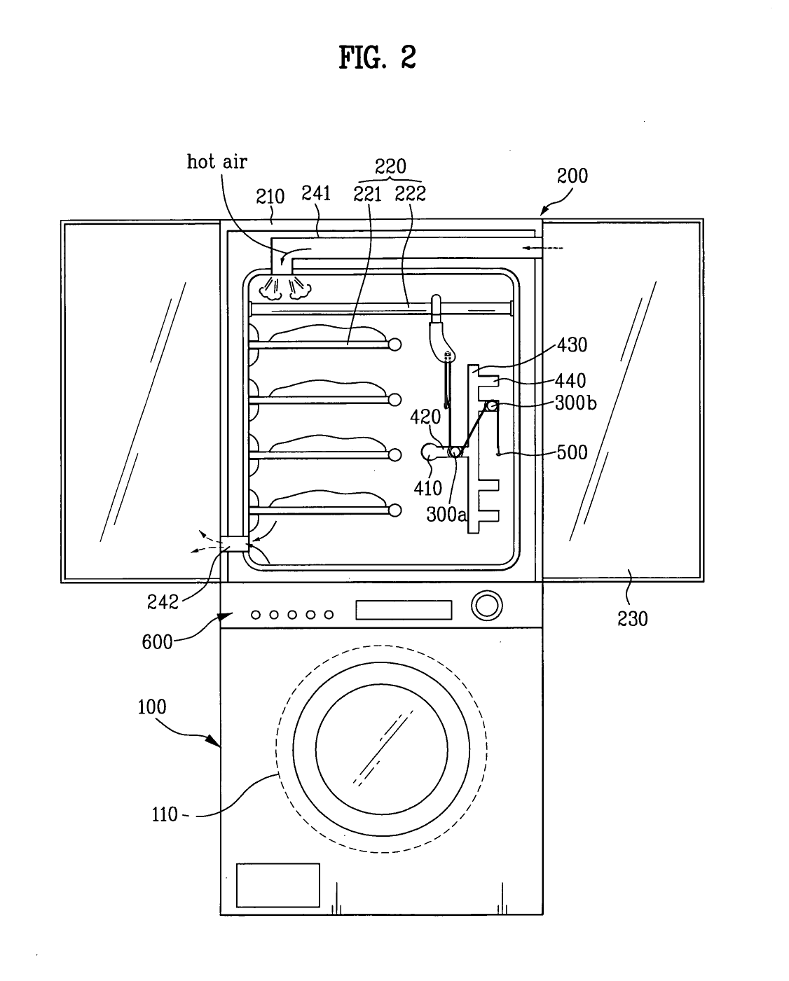

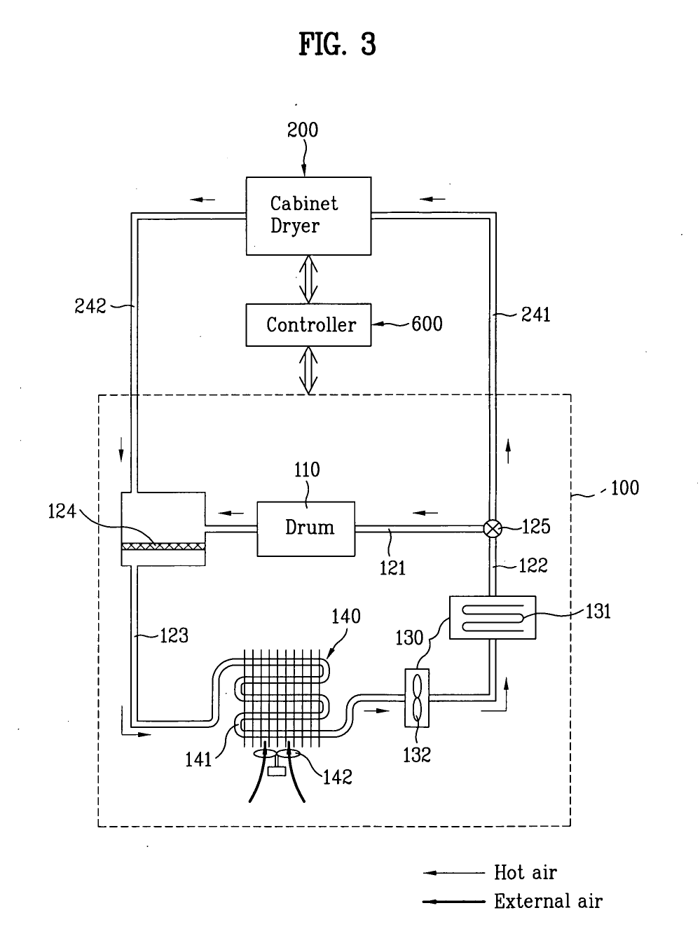

FIG. 2 is a front view schematically illustrating a configuration of a composite washing system according to an exemplary embodiment of the present invention. FIG. 3 is a block diagram schematically illustrating the configuration of the composite washing system according to the exemplary embodiment of the present invention.

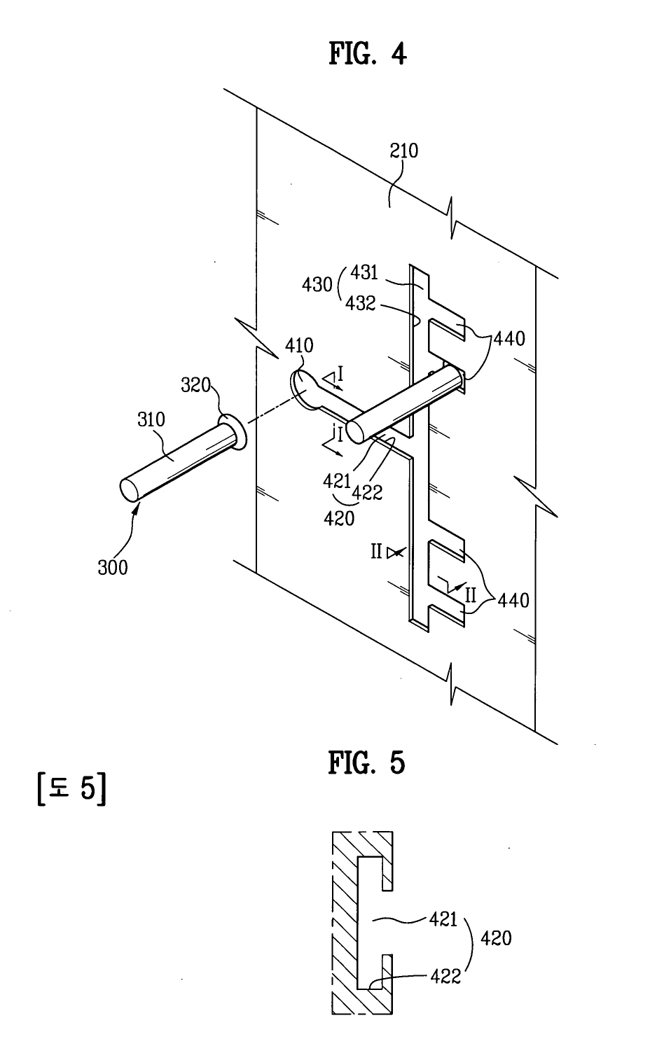

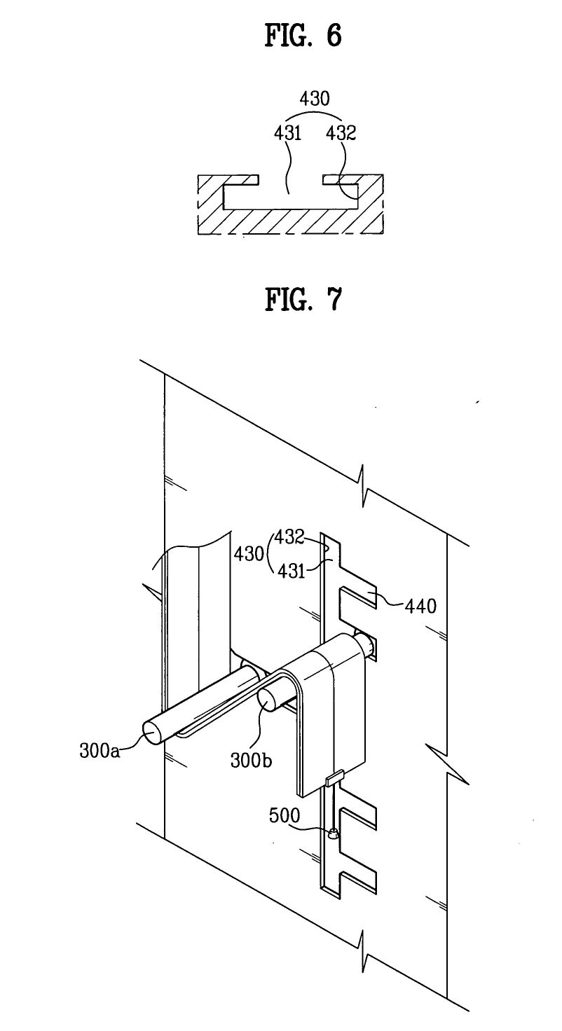

FIG. 4 is a perspective view illustrating a structure of a laundry folder according to an exemplary embodiment of the present invention. FIG. 5 is a cross-sectional view taken along the line I-I of FIG. 4. FIG. 6 is a cross-sectional view taken along the line II-II of FIG. 4.

FIG. 7 is a perspective view illustrating a state in which laundry is hung on the laundry folder according to the exemplary embodiment of the present invention.

As shown in FIGS. 2 and 3, the composite washing system according to the exemplary embodiment of the present invention mainly includes a drum dryer 100, a cabinet dryer 200, a laundry folder, and a controller 600.

The drum dryer 100 performs an operation to dry laundry.

The drum dryer 100 may include a drying drum 110 which can perform a rotating operation and a stirring operation, a hot air supply path, a hot air supplier 130, and an air condenser 140.

The hot air supply path is a path to guide a flow of hot air. The hot air supply path communicates with an inner space defined in the system among the drying drum 110, air condenser 140, and cabinet dryer 200.

For example, the hot air supply path may include a first air supply duct 121 which supplies hot air into the drying drum 110, and a second air supply duct 122 which receives air emerging from the air condenser 140, and guides the received air into the first air supply duct 121 or a hot air inlet duct 241 of the cabinet dryer 200. The hot air supply path may further include a third air supply duct 123 which receives air emerging from the drying drum 110, and guides the received air into the air condenser 140.

A filter 124 may also be arranged in the third air supply duct 123 to filter air passing through the third air supply duct 123, and thus, to remove foreign matter contained in the air.

The hot air supplier 130 is arranged in the second air supply duct 122 to produce hot air.

For example, the hot air supplier 130 may include a drying heater 131 which heats air passing through the second air supply duct 122, and a blowing fan 132 which forcibly blows the air heated in the second air supply duct 122.

Preferably, the blowing fan 132 is arranged in a portion of the second air supply duct 122 upstream from the drying heater 131, in order to minimize any damage to the blowing fan 132 caused by hot air.

The air condenser 140 condenses air flowing through the third air supply duct 123, and radiates heat from the air. The air condenser 140 may include a condenser 141 and a condensing fan 142.

The condenser 141 is configured to receive hot air from the third air supply duct 123 of the hot air supply path. The condenser 141 may include a pipe having a plurality of bent portions, and cooling fins arranged around the pipe.

The condensing fan 142 is adapted to blow external air toward the condenser 141.

Accordingly, humid air passing through the condenser 141 is condensed as it heat-exchanges with the external air supplied in accordance with the operation of the condensing fan 142 while passing through the pipe of the condenser 141.

The cabinet dryer 200 is defined with a laundry compartment to receive a large amount of laundry. The cabinet dryer 200 may be coupled to a portion of the drum dryer 100. In the exemplary embodiment of the present invention, the cabinet dryer 200 is illustrated as being coupled to the top of the drum dryer 100.

In this case, in addition to the hot air inlet duct 241, the cabinet dryer 200 mainly includes a body 210, a laundry support 220, an opening/closing door 230, and an air outlet duct 242.

The body 210 defines an appearance of the cabinet dryer 200, and is open at the front thereof.

The laundry support 220 is mounted in the body 210. The laundry support 220 may include a plurality of shelves 221, and a hanger bar 222.

Each shelf is detachably mounted in the body 210. The hanger bar 222 is detachably mounted to the body 210 in an upper space of the body 210.

The opening/closing door 230 is mounted to the front of the body 210 to open/close the open front of the body 210.

The hot air inlet duct 241 has one end connected to the second air supply duct 122 of the drum dryer 100, and the other end communicating with the interior of the body 210. Accordingly, the hot air inlet duct 241 receives hot air from the second air supply duct 122, and guides the received hot air into the body 210.

Preferably, a valve 125 is arranged in the second air supply duct 122 to guide the air flowing through the second air supply duct 122 toward the first air supply duct 121 and/or the hot air inlet duct 241.

The air outlet duct 242 has one end communicating with the body 210, and the other end connected to the third air supply duct 123 of the hot air supply path. Accordingly, the air outlet duct 242 functions to discharge hot and humid air passing through the laundry in the body 210.

A separate discharge fan (not shown) may be arranged in the air outlet duct 242.

The laundry folder according to the exemplary embodiment of the present invention is adapted to enable laundry having a long length to be received in the cabinet dryer without being wrinkled.

FIG. 4 illustrates the structure of the laundry folder according to the exemplary embodiment of the present invention. FIG. 5 illustrates a cross-sectional structure of a first guide included in the laundry folder. FIG. 6 illustrates a cross-sectional structure of a second guide included in the laundry folder.

The laundry folder will be described in detail with reference to FIG. 4.

The laundry folder may include at least one folding rod 300 which is detachably mounted in the body 210 of the cabinet dryer 200 to fold a portion of laundry, and a folding rod guide which is provided at the body 210 of the cabinet dryer 200 to hold the folding rod 300 in a fixed state and to guide movement of the folding rod 300.

The folding rod 300 includes an elongated seat member 310, and a position fixing member 320 which extends from one end of the seat member 310.

The seat member 310 supports a portion of laundry in a state in which the laundry portion is wrapped around or laid on the seat member 310 without being wrinkled.

Preferably, the seat member 310 has a circular cross-section in order to allow laundry to be seated on the seat member 310 without being wrinkled.

The position fixing member 320 functions to fix the seat member 310 at a desired position in the body 210 of the cabinet dryer 200 while allowing the seat member 310 to be movable.

The position fixing member 320 also functions to prevent the seat member 310 from being unintentionally separated from the fixed position.

The laundry folder may include one or more folding rods 300 in accordance with the length of the laundry to be folded by the laundry folder. Where the laundry folder includes two folding rods 300, namely, a first folding rod 300a and a second folding rod 300b, as shown in FIG. 7, the first folding rod 300a folds a portion of laundry in a state in which the laundry portion is wrapped around the first folding rod 300a, and the second folding rod 300b folds another portion of the folded laundry portion in a state in which the laundry portion is laid on the second folding rod 300b.

Meanwhile, the folding rod guide includes an insertion groove 410, a first guide 420, a second guide 430, and a plurality of fixing grooves 440.

Preferably, the insertion groove 410 has the same shape as that of the position fixing member 320 in order to allow an easy insertion of the position fixing member 320 through the insertion groove 410. More preferably, the insertion groove 410 has a size allowing the position fixing member 320 to be inserted through the insertion groove 410.

The first guide 420 extends horizontally from the insertion groove 410. The first guide 420 functions to guide a horizontal movement of the position fixing member 320 of the folding rode 300 inserted in the insertion groove 410.

As shown in FIG. 5, the first guide 420 includes a first guide groove 421 which extends horizontally to allow a horizontal movement of the position fixing member 320 along the first guide 420, and first separation preventing grooves 422 which are formed along opposite longitudinal edges of the first guide groove 421, respectively, to prevent the position fixing member 320 from being separated from the first guide groove 421.

The second guide 430 extends vertically from the first guide 420, and functions to guide a vertical movement, namely, an upward or downward movement, of the folding rod 300 which has been horizontally moved along the first guide 420.

As shown in FIG. 6, the second guide 430 includes a second guide groove 431 which extends vertically to allow a vertical movement of the position fixing member 320 along the second guide 430, and second separation preventing grooves 432 which are formed along opposite longitudinal edges of the second guide groove 431, respectively, to prevent the position fixing member 320 from being separated from the second guide groove 431.

Each fixing groove 440 is formed at one longitudinal edge of the second guide 430 in order to fix the folding rod 300 which has moved along the second guide 430.

Meanwhile, in accordance with the exemplary embodiment of the present invention, it is preferred that the laundry folder further include a weight 500 which prevents the laundry supported by the folding rod 300 in a seated state from being separated from the folding rod 300, and smoothes out wrinkles on the laundry during the drying operation.

As shown in FIG. 7, it is preferred that the weight 500 be provided, at one end thereof, with a nipper, in order to allow the weight 500 to be easily attached to a lower end of the laundry.

Thus, the weight 500 applies a load to the laundry seated on the seat member 310 of the folding rod 300 in a gravity direction, thereby preventing the laundry from being separated from the seat member 310 while smoothing out wrinkles on the laundry during the drying operation.

The controller 600 according to the exemplary embodiment of the present invention controls the operations of the drum dryer 100 and cabinet dryer 200.

The controller 600 may be equipped in one of the drum dryer 100 and cabinet dryer 200, or may be equipped in either the drum dryer 100 or the cabinet dryer 200. In the exemplary embodiment of the present invention, the controller 600 is illustrated as being equipped in the drum dryer 100.

Where two controllers 600 are equipped in the drum dryer 100 and cabinet dryer 200, respectively, it is preferred that the two controllers 600 be connected by a data cable (not shown), for information transfer therebetween.

Meanwhile, the controller 600 may be configured to control the drum dryer 100 and cabinet dryer 200 in an independent manner or in a linked manner.

Hereinafter, the drying operation and functions of the composite washing system provided with the laundry folder in accordance with the exemplary embodiment of the present invention will be described.

First, laundry is laid on the shelves 221, or is hung on the hanger bar 222 in the body 210 of the cabinet dryer 200.

If the laundry to be hung on the hanger bar 221 has a long length, the folding rods 300a and 300b are mounted.

In this case, the position fixing member 320 of the second folding rod 300b is first inserted into the insertion groove 410 of the folding rod guide. In this state, the position fixing member 320 of the second folding rod 300b is moved along the first guide groove 421 of the first guide 420.

Thereafter, the position fixing member 320 of the second folding rod 300b is vertically moved along the second guide groove 431 of the second guide 430 to a fixing level at which the laundry does not come into contact with the bottom of the cabinet dryer 200. The fixing level may be appropriately determined in accordance with the length of the laundry. Subsequently, the position fixing member 320 of the second folding rod 300b is firmly fitted in the fixing groove 440 corresponding to the fixing level. As described above, the fixing groove 440 is formed at one longitudinal edge of the second guide 430. Thus, the second folding rod 300b is fixedly mounted to the body 210 of the cabinet dryer 200.

Thereafter, the first folding rod 300a is inserted into the insertion groove 410 of the folding rod guide, and is then moved along the first guide 420 to a desired position.

In this state, a portion of the laundry is wrapped around the bottom of the first folding rod 300a such that the laundry is folded. Thereafter, the laundry is seated on the top of the second folding rod 300b.

Meanwhile, if the laundry is likely to slip off the second folding rod 300b, the weight 500 is attached to the lower end of the laundry in order to prevent the laundry from slipping off the second folding rod 300b.

After the hanging of the laundry is completely achieved in the above-described manner, electric power is supplied to the hot air supplier 130, thereby causing hot air to be supplied to the second air supply duct 122 of the hot air supply path.

Thereafter, the valve 125 is controlled to guide the hot air flowing through the second air supply duct 122 into the hot air inlet duct 241 of the cabinet dryer 200.

The hot air introduced into the hot air inlet duct 241 is discharged into the body 210 of the cabinet dryer 200. Thus, the laundry is dried.

The air which has become humid after being used to dry the laundry is guided through the condenser 140, so that the air is dried while being condensed to remove moisture therefrom. The dried air is then heated to a high temperature while passing through the drying heater 131. The resultant hot air is then re-supplied to the body 210 of the cabinet dryer 200.

Thus, the laundry is dried as the above-described air flow is repeated for a predetermined time.

The above-described composite washing system according to the present invention has various advantages as follows.

First, air flowing in the drum dryer and cabinet dryer is continuously circulated without being discharged out of the dryers in accordance with the present invention. Accordingly, the air used in the drying cycle has no influence on the indoor environment. Therefore, the present invention can provide a composite washing system having a suitable built-in structure.

Second, in accordance with the present invention, humid air discharged from the drum dryer and cabinet dryer is condensed by the air condenser, so that moisture contained in the air is removed. Accordingly, it is possible to effectively dry laundry.

Third, in accordance with the present invention, the cabinet dryer is equipped with the laundry folder. Accordingly, it is possible to dry laundry having a long length in a state of receiving the laundry in the cabinet dryer without wrinkling the laundry, and thus, to enhance the reliability of the composite washing system.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A composite washing system comprising:
a drum dryer which dries laundry to be dried, and includes a drying drum adapted to receive the laundry, a hot air supply path adapted to guide a flow of hot air, a hot air supplier arranged in the hot air supply path to generate the hot air, and an air condenser adapted to condense the hot air;
a cabinet dryer which is coupled to one side of the drum dryer, and is defined with a laundry receiving compartment, the cabinet dryer including a hot air inlet duct adapted to receive the hot air flowing through the hot air supply path; and
a laundry folder which is disposed in the cabinet dryer to receive laundry having a long length without wrinkling the laundry.

2. The composite washing system according to claim 1, wherein the hot air supply path includes:
a first air supply duct which guides the hot air into the drying drum;
a second air supply duct which is connected to the first air supply duct and the hot air inlet duct to guide the hot air generated from the hot air supplier into at least one of the first air supply duct and the hot air inlet duct; and
a third air supply duct which guides air discharged from the drying drum to the air condenser.

3. The composite washing system according to claim 2, further comprising:
a filter which is arranged in the third air supply duct to filter the air discharged from the drying drum, and thus, to remove foreign matter contained in the discharged air.

4. The composite washing system according to claim 1, wherein the laundry folder includes:
at least one folding rod which is detachably mounted in the cabinet dryer to fold a portion of the laundry; and
a folding rod guide which is disposed in the cabinet dryer to hold the folding rod in a fixed state and to guide a movement of the folding rod.

5. The composite washing system according to claim 4, wherein the folding rod includes:
a seat member on which the laundry is seated; and
a position fixing member which extends from one end of the seat member to fix a position of the folding rod.

6. The composite washing system according to claim 5, wherein the folding rod guide includes:
an insertion groove in which the position fixing member of the folding rod is insertable;
a first guide which extends horizontally from the insertion groove to guide a horizontal movement of the folding rod;
a second guide which extends vertically from the first guide to guide a vertical movement of the folding rod; and
at least one fixing groove which is formed at one side of the second guide to fix a position of the folding rod.

7. The composite washing system according to claim 6, wherein the first guide includes:
a first guide groove which receives the position fixing member of the folding rod to allow the position fixing member to move along the first guide; and
first separation preventing grooves which are formed along opposite edges of the first guide groove, respectively, to prevent the position fixing member from being separated from the first guide groove.

8. The composite washing system according to claim 6, wherein the second guide includes:
a second guide groove which receives the position fixing member of the folding rod to allow the position fixing member to move along the second guide; and
second separation preventing grooves which are formed along opposite edges of the second guide groove, respectively, to prevent the position fixing member from being separated from the second guide groove.

9. The composite washing system according to claim 1, further comprising:
a laundry support which is disposed in the cabinet dryer to support the laundry in the cabinet dryer.

10. The composite washing system according to claim 9, wherein the laundry support includes:
at least one shelf detachably mounted in the cabinet dryer to support the laundry in such a manner that the laundry is laid on the shelf; and
a hanger bar detachably mounted in the cabinet dryer at an upper portion of the cabinet dryer to support the laundry in such a manner that the laundry is hung on the hanger bar.

11. A composite washing system comprising:
a drum dryer which dries laundry to be dried, and includes a drying drum adapted to receive the laundry, a hot air supply path adapted to guide a flow of hot air, a hot air supplier arranged in the hot air supply path to generate the hot air, and an air condenser adapted to condense the hot air;
a cabinet dryer which is coupled to one side of the drum dryer, and is defined with a laundry receiving compartment, the cabinet dryer including a hot air inlet duct adapted to receive the hot air flowing through the hot air supply path;
at least one folding rod which is detachably mounted in the cabinet dryer to fold a portion of the laundry;
a folding rod guide which is disposed in the cabinet dryer to hold the folding rod in a fixed state and to guide a movement of the folding rod; and
a weight which prevents the laundry seated on the folding rod in a folded state from being separated from the folding rod.

12. The composite washing system according to claim 11, wherein the hot air supply path includes:
a first air supply duct which guides the hot air into the drying drum;
a second air supply duct which is connected to the first air supply duct and the hot air inlet duct to guide the hot air generated from the hot air supplier into at least one of the first air supply duct and the hot air inlet duct; and
a third air supply duct which guides air discharged from the drying drum to the air condenser.

13. The composite washing system according to claim 12, further comprising:
a valve which is arranged in a portion of the second air supply duct connected to the first air supply duct and the hot air inlet duct, and selectively guides the hot air flowing through the second air supply duct into at least one of the first air supply duct and the hot air inlet duct.

14. The composite washing system according to claim 11, further comprising:
a filter which is arranged in the third air supply duct to filter the air discharged from the drying drum, and thus, to remove foreign matter contained in the discharged air.

15. The composite washing system according to claim 11, wherein the folding rod includes:
a seat member on which the laundry is seated; and
a position fixing member which extends from one end of the seat member to fix a position of the folding rod.

16. The composite washing system according to claim 15, wherein the folding rod guide includes:
an insertion groove in which the position fixing member of the folding rod is insertable;
a first guide which extends horizontally from the insertion groove to guide a horizontal movement of the folding rod;
a second guide which extends vertically from the first guide to guide a vertical movement of the folding rod; and
at least one fixing groove which is formed at one side of the second guide to fix a position of the folding rod.

17. The composite washing system according to claim 16, wherein the first guide includes:
a first guide groove which receives the position fixing member of the folding rod to allow the position fixing member to move along the first guide; and
first separation preventing grooves which are formed along opposite edges of the first guide groove, respectively, to prevent the position fixing member from being separated from the first guide groove.

18. The composite washing system according to claim 16, wherein the second guide includes:
a second guide groove which receives the position fixing member of the folding rod to allow the position fixing member to move along the second guide; and
second separation preventing grooves which are formed along opposite edges of the second guide groove, respectively, to prevent the position fixing member from being separated from the second guide groove.

19. The composite washing system according to claim 11, further comprising:
a laundry support which is disposed in the cabinet dryer to support the laundry in the cabinet dryer.

20. The composite washing system according to claim 19, wherein the laundry support includes:
at least one shelf detachably mounted in the cabinet dryer to support the laundry in such a manner that the laundry is laid on the shelf, and
a hanger bar detachably mounted in the cabinet dryer at an upper portion of the cabinet dryer to support the laundry in such a manner that the laundry is hung on the hanger bar.
